(19) United States
(12) Patent Application Publication
(10) Pub. No.: US 2017/0349806 A1
(43) Pub. Date: Dec. 7, 2017

(54) BINARY MIXTURE SYSTEMS

(71) Applicants: Joshua Mathias, Surrey (CA); Radek Hlavacek, Surrey (CA); Martin Knezicky, Surrey (CA); Vojtech Pokorny, Surrey (CA)

(72) Inventors: Joshua Mathias, Surrey (CA); Radek Hlavacek, Surrey (CA); Martin Knezicky, Surrey (CA); Vojtech Pokorny, Surrey (CA)

(21) Appl. No.: 15/175,306

(22) Filed: Jun. 7, 2016

(51) Int. Cl. C09K 8/52; E21B 43/24

(52) U.S. Cl. CPC C09K 8/52; E21B 43/24

(57) ABSTRACT

A binary mixture system for lower oil viscosity and increased oil flow. The binary mixture composition may be useful for introduction into a functioning oil reservoir for cleaning and stimulation. The binary mixture composition is made of a first-chemical composition, a second-chemical composition, and a third-chemical composition. The first-chemical composition may be ammonium nitrate-water. The first-chemical composition may have a ratio of 1.0 to the second-chemical composition and the third-chemical composition. The first-chemical composition may be heated to a temperature of sixty degrees celsius. The second-chemical composition is made of the sodium nitrite-water. The second-chemical composition may have a ratio of 1.56 to the first-chemical composition and the third-chemical composition. The second-chemical composition may also be heated to a temperature of sixty degrees celsius. The third-chemical composition is made of phosphoric acid-water. The third-chemical composition may have a ratio of 0.2 to the first-chemical composition and the second-chemical composition.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of oil reservoir maintenance and more specifically relates to binary mixture systems.

### 2. Description of Related Art

The production of oil or gas from underground reservoirs involves chemical and mechanical processes that affect the wellbore. Many of these processes can eventually cause a problem with the well, resulting either in a decrease in production or in failure of equipment installed downhole or at the surface. Restrictions can occur in the formation or within the wellbore that can cause a decrease in oil or gas production. These restrictions are a result of changes in the formation or fluid properties around the wellbore, chemical reactions within the formation or the wellbore, mechanical problems, or inadequate completion techniques. Most of the serious problems can be avoided or delayed through preventive maintenance techniques or early recognition from regular analysis of producing rates, fluids, and the mechanical condition of the well. Such practices can prevent a costly workover that may be required to restore production from the well and may also prevent total loss of the wellbore. A suitable solution is desired.

Several attempts have been made to solve the above-mentioned problems such as those found in U.S. Pat. No. 8,387,697 to Alexandrov et. al., U.S. Pat. No. 9,228,424 to Zavolzhskiy et. al., U.S. Pat. No. 6,488,086 to Daragan et. al., U.S. Pat. No. 6,672,388 to McGregor et. al., 2013/0206400 to Alexandrov et. al, and 2013/0014950 to Dickinson. This art is representative of oil reservoir maintenance. However, none of the above inventions and patents, taken either singly or in combination, is seen to describe the invention as claimed.

Preferably, oil reservoir maintenance via binary mixture systems should provide lower oil viscosity and increased oil flow and, yet would operate reliably and be manufactured at a modest expense. Thus, a need exists for a reliable binary mixture system to avoid the above-mentioned problems.

### BRIEF SUMMARY OF THE INVENTION

In view of the foregoing disadvantages inherent in the known oil reservoir maintenance art, the present invention provides a novel oil reservoir maintenance means. The general purpose of the present invention, which will be described subsequently in greater detail is to provide lower oil viscosity and increased oil flow.

A binary mixture system (and method) is disclosed herein and may comprise a binary mixture composition. The binary mixture composition may be useful for introduction into a functioning oil reservoir for cleaning and stimulation. The binary mixture composition may comprise an introduction speed to the oil reservoir of nine liters per second. The binary mixture composition may comprise the first-chemical composition, the second-chemical composition, and the third-chemical composition. The first-chemical composition may comprise ammonium nitrate-water. The first-chemical composition may comprise sixty percent ammonium nitrate by weight. The first-chemical composition may comprise forty-percent-water by weight. The first-chemical composition may comprise a ratio of 1.0 to the second-chemical composition and the third-chemical composition. The first-chemical composition may be heated in a tank. The first-chemical composition may comprise a first-heated temperature of sixty degrees Celsius.

The second-chemical composition may comprise the sodium nitrite-water. The second-chemical composition may comprise forty percent sodium nitrite by weight. The second-chemical composition may comprise sixty-percent-water by weight. The second-chemical composition may comprise a ratio of 1.56 to the first-chemical composition and the third-chemical composition. The second-chemical composition may be heated in a vessel. The second-chemical composition may comprise a second-heated temperature of sixty degrees Celsius.

The third-chemical composition may comprise the phosphoric acid-water. The third-chemical composition may comprise eighty-three percent phosphoric acid by weight. The third-chemical composition may comprise seventeen-percent-water by weight. The third-chemical composition may comprise a ratio of 0.2 to the first-chemical composition and the second-chemical composition. The third-chemical composition may comprise an ambient temperature profile. In this way a preferred embodiment of the present invention may be used as per the subsequent method of use.

The binary mixture system may comprise a kit including a first-chemical composition, a second-chemical composition, a third-chemical composition, and a set of user's instructions.

A method of using a binary mixture system may comprise the steps of placing a desired quantity of a first-chemical composition in a tank; placing a desired quantity of a second-chemical composition in a vessel; placing a desired quantity of a third-chemical composition in a receptacle; heating the first-chemical composition and the second-chemical composition to a temperature of sixty degrees Celsius; attaching the tank, the vessel, and the receptacle to hose lines; releasing the first-chemical composition, the second-chemical composition, and the third-chemical composition into an oil reservoir at a volume of nine liters per second; monitoring a pressure and the temperature of combined the first-chemical composition, the second-chemical composition, and the third-chemical composition; discontinuing heating to the first-chemical composition, the second-chemical composition when the temperature of combined the first-chemical composition, the second-chemical composition, and the third-chemical composition reaches eighty degrees Celsius; maintaining a working temperature within a range of two-hundred to two-hundred-fifty degrees Celsius; and discontinuing the release of the first-chemical composition, the second-chemical composition, and the third-chemical composition into the oil reservoir when no longer desired.

The present invention holds significant improvements and serves as novel oil reservoir maintenance means. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, binary mixture system, constructed and operative according to the teachings of the present invention.

FIG. 1 shows a perspective view illustrating a binary mixture system during an ‘in-use’ condition showing a binary mixture assembly according to an embodiment of the present invention.

FIG. 2 is a perspective view illustrating the binary mixture assembly comprising a first-chemical composition, a second-chemical composition, and a third-chemical composition according to an embodiment of the present invention of FIG. 1.

FIG. 3 is a composition breakdown view illustrating the binary mixture assembly according to an embodiment of the present invention of FIGS. 1-2.

FIG. 4 is a perspective view illustrating an alternative embodiment of a binary mixture assembly according to an alternative embodiment of the present invention of FIGS. 1-3.

FIG. 5 is a flowchart illustrating a method of use for the binary mixture system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to oil reservoir maintenance and more particularly to a binary mixture system as used to lower oil viscosity and increase oil flow.

Generally speaking, a binary mixture system provides a cost efficient and environmentally safe method to maintain an oil reservoir. The chemicals are injected into the productive zone through separate channels. The reaction rapidly generate gases/water vapor upon mixture, resulting in significant heating and pressurization of the payzone. Use of the separate lines is important because the chemicals react instantly and quickly produce exhaust gas and heat. The result is significantly lower oil viscosity and increased oil flows. The technology can be used in various reservoir types and it is particularly applicable in secondary or tertiary recoveries and in production of heavy oil at highly competitive costs. No infrastructure is required. No large amount of water required. No special tools and equipment are required either, because the pump trucks, chemical tanks, packers, pipes and measuring equipment are those that administer other chemical treatment to the reservoir. In addition, no special tools are required, because the pump trucks, packers, pipes are those that administer other chemical treatments to the reservoir.

The measuring system is also the same as used throughout the industry for measuring temperature and pressure in the reservoir. The delivery system provides near 100% efficiency, since the reaction takes place within the oil reservoir. In comparison to other methods, losses of energy are minimal as the binary mixture system is not limited to depth as is the steam assisted gravity drainage method. There is no release of oxygen in process. The maximum amount of the energy released is 1,185 KJ for 1 kg of dry ammonium nitrate. Further, large amounts of water do not need to be injected. For small scale treatments, there is an option to mix the chemicals to their proportions on side using tanks with pump circulation to mix the solution. For large scale treatments, chemicals are available locally and can be ordered in heated tanks and delivered to the site.

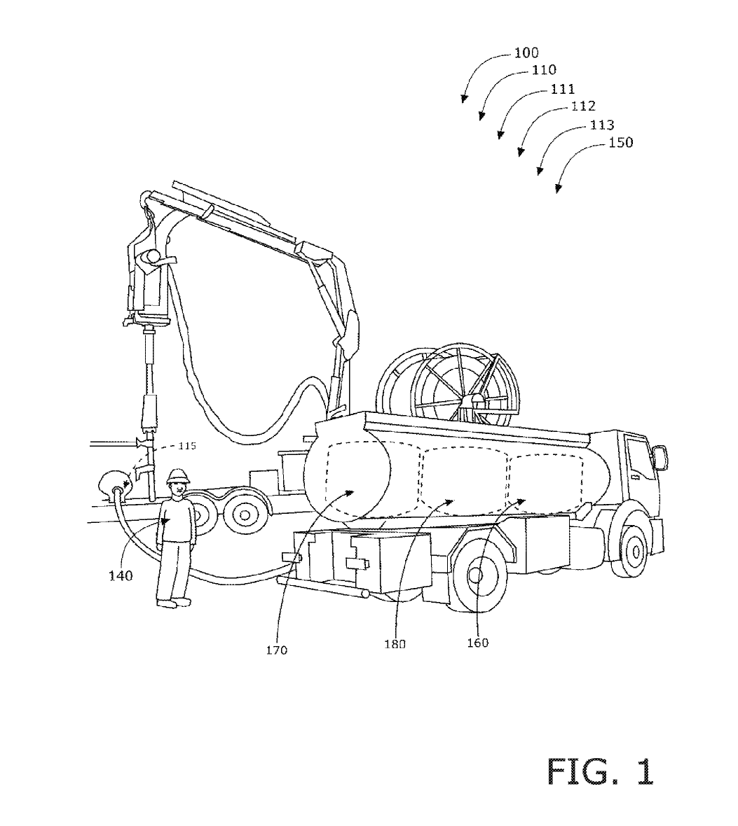

Referring to the drawings by numerals of reference there is shown in FIG. 1, binary mixture system 100 during an ‘in-use’ condition 150 showing user 140 operating a binary mixture system 100. Binary mixture system 100 may comprise binary mixture composition 110. Binary mixture composition 110 may be useful for introduction into a functioning oil reservoir 115 for cleaning and stimulation 113. Binary mixture composition 110 may comprise an introduction speed 111 to oil reservoir 115 of nine liters per second 112. Other introduction speeds may be used. Binary mixture composition 110 may comprise first-chemical composition 160, second-chemical composition 170, and third-chemical composition 180.

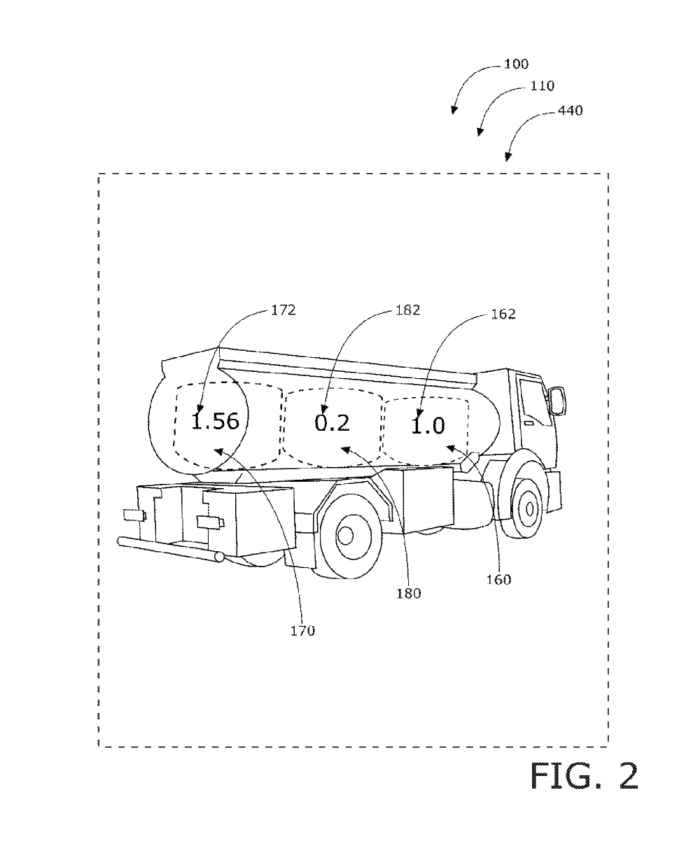

Referring now to FIG. 2, binary mixture system 100 may be sold as kit 440 comprising the following parts: at least one first-chemical composition 160; at least one second-chemical composition 170; at least one third-chemical composition 180; and a set of user's instructions. The kit has instructions such that functional relationships are detailed in relation to the structure of the invention (such that the invention can be used, maintained, or the like in a preferred manner). Binary mixture system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different chemical and induction combinations, parts may be sold separately, etc., may be sufficient.

In further referring to FIG. 2, a perspective view of binary mixture composition 110. Binary mixture composition 110 may comprise first-chemical composition 160, second-chemical composition 170, and third-chemical composition 180. First-chemical composition 160 may comprise a ratio of 1.0 162 to second-chemical composition 170 and third-chemical composition 180. Second-chemical composition 170 may comprise a ratio of 1.56 172 to first-chemical composition 160 and third-chemical composition 180. Further, third-chemical composition 180 may comprise a ratio of 0.2 182 to first-chemical composition 160 and second-chemical composition 170.

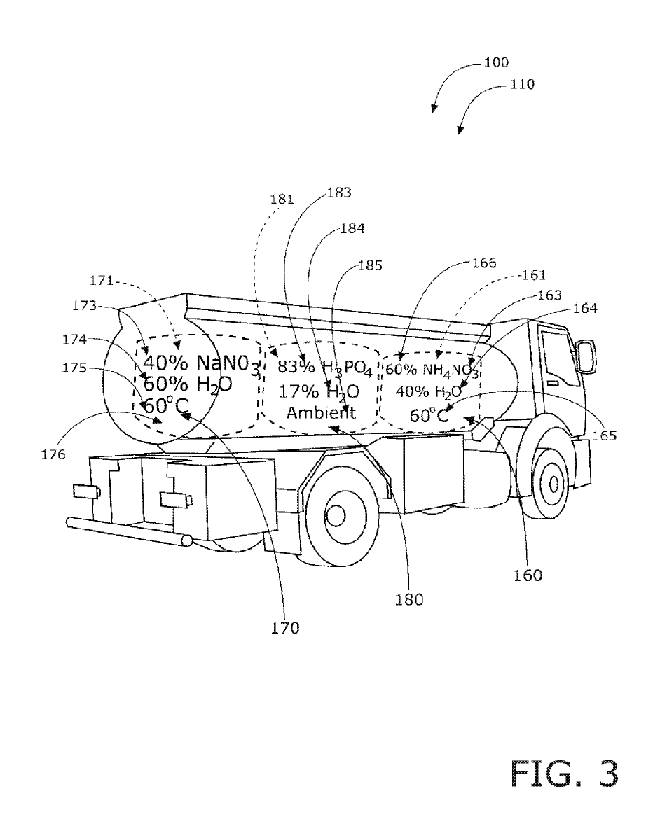

Referring now to FIG. 3, a composition breakdown view of binary mixture composition 110. First-chemical composition 160 may comprise ammonium nitrate-water 161. First-chemical composition 160 may comprise sixty percent ammonium nitrate by weight 163. First-chemical composition 160 may comprise forty-percent-water by weight 164. First-chemical composition 160 may comprise a first-heated temperature of sixty degrees celsius 165. Further, first-chemical composition 160 may be heated in tank 166.

In continuing to refer to FIG. 3, second-chemical composition 170 may comprise sodium nitrite-water 171. The second-chemical composition 170 may comprise forty percent sodium nitrite by weight 173. Second-chemical composition 170 may comprise sixty-percent-water by weight 174. Second-chemical composition 170 may comprise a second-heated temperature of sixty degrees celsius 175. Further second-chemical composition 170 may be heated in a vessel 176.

In further referring to FIG. 3, third-chemical composition 180 may comprise phosphoric acid-water 181. Third-chemical composition 180 may comprise eighty-three percent phosphoric acid by weight 183. Third-chemical composition 180 may comprise seventeen-percent-water by weight 184. Further, third-chemical composition 180 may comprise an ambient temperature profile 185.

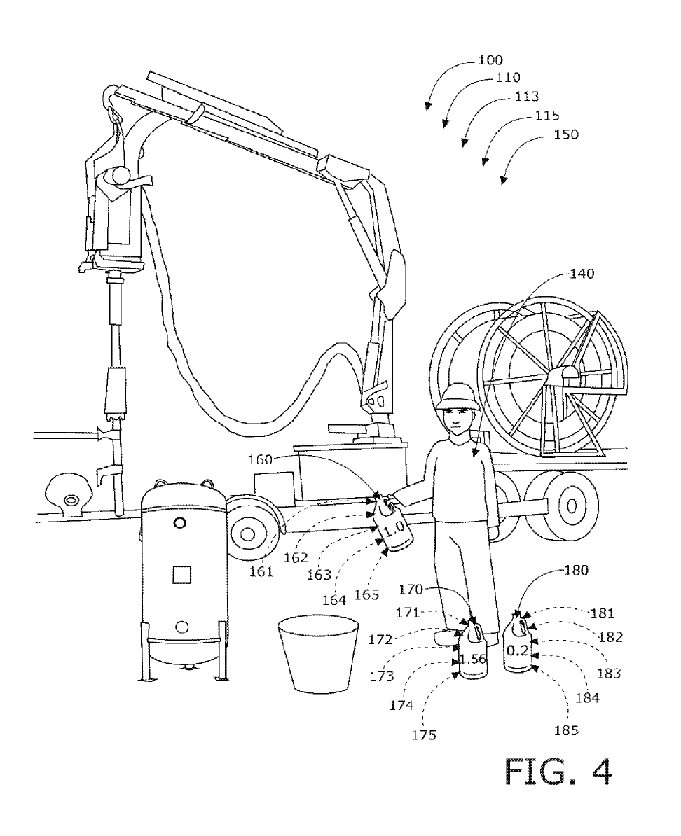

Referring now to FIG. 4, an alternative embodiment of binary mixture system 100 on a smaller scale with smaller tanks. Binary mixture composition 110 may be useful for introduction into a functioning oil reservoir 115 for cleaning and stimulation. First-chemical composition 160 may comprise ammonium nitrate-water 161. First-chemical composition 160 may comprise a ratio of 1.0 162 to second-chemical composition 170 and third-chemical composition 180. First-chemical composition 160 may comprise sixty percent ammonium nitrate by weight 163. First-chemical composition 160 may comprise forty-percent-water by weight 164. Further, first-chemical composition 160 may comprise a first-heated temperature of sixty degrees celsius 165.

In continuing to refer to FIG. 4, second-chemical composition 170 may comprise sodium nitrite-water 171. Second-chemical composition 170 may comprise a ratio of 1.56 172 to first-chemical composition 160 and third-chemical composition 180. Second-chemical composition 170 may comprise forty percent sodium nitrite by weight 173. Second-chemical composition 170 may comprise sixty-percent-water by weight 174. Further, second-chemical composition 170 may comprise second-heated temperature of sixty degrees celsius 175.

In further referring to FIG. 4, third-chemical composition 180 may comprise phosphoric acid-water 181. Third-chemical composition 180 may comprise eighty-three percent phosphoric acid by weight 183. Third-chemical composition 180 may comprise seventeen-percent-water by weight 184. Third-chemical composition 180 may comprise a ratio of 0.2 182 to first-chemical composition 160 and second-chemical composition 170. Those with ordinary skill in the art will now appreciate that upon reading this specification and by their understanding the art of binary mixture system as described herein, methods of oil reservoir maintenance via chemical introduction will be understood by those knowledgeable in such art.

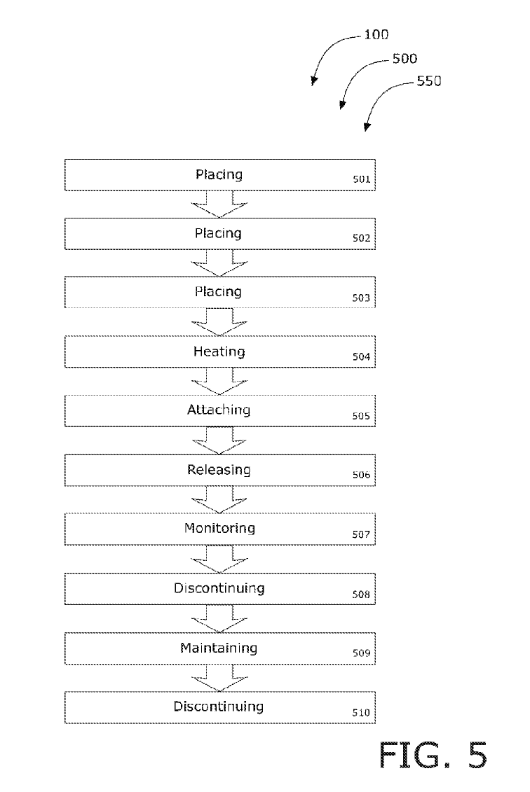

Referring now to FIG. 5 showing flowchart 550 illustrating method of use 500 for binary mixture system 100 according to an embodiment of the present invention of FIGS. 1-4.

As shown, method of use 500 may comprise the steps of: step one 501, placing a desired quantity of a first-chemical composition 160 in a tank 166; step two 502, placing a desired quantity of a second-chemical composition 170 in a vessel 176; step three 503, placing a desired quantity of a third-chemical composition 180 in a receptacle; step four 504, heating the first-chemical composition 160 to a first-heated temperature of sixty degrees celsius 165 and the second-chemical composition 170 to a second-heated temperature of sixty degrees celsius 175; step five 505, attaching the tank 166, the vessel 176, and the receptacle to hose lines; step six 506, releasing the first-chemical composition 160, the second-chemical composition 170, and the third-chemical composition 180 into an oil reservoir 115 at a volume of nine liters per second; step seven 507, monitoring the pressure and the temperature of the combined first-chemical composition 160, second-chemical composition 170, and third-chemical composition 180; step eight 508, discontinuing heating to the first-chemical composition 160, and the second-chemical composition 170 when the temperature of the combined first-chemical composition 160, second-chemical composition 170, and third-chemical composition 180 reaches eighty degrees celsius; step nine 509, maintaining a working temperature within a range of two-hundred to two-hundred-fifty degrees celsius; and step ten 510, discontinuing the release of the first-chemical composition 160, the second-chemical composition 170, and the third-chemical composition 180 into the oil reservoir 115 when no longer desired.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A binary mixture system comprising:
a binary mixture composition comprising;
a first-chemical composition comprising;
ammonium nitrate-water;
a second-chemical composition comprising;
sodium nitrite-water; and
a third-chemical composition comprising;
phosphoric acid-water;
wherein said binary mixture system comprises said binary mixture composition;
wherein said binary mixture composition comprises said first-chemical composition, said second-chemical composition, and said third-chemical composition;
wherein said first-chemical composition comprises said ammonium nitrate-water;
wherein said second-chemical composition comprises said sodium nitrite-water;
wherein said third-chemical composition comprises said phosphoric acid-water; and
wherein said binary mixture composition is useful for introduction into a functioning oil reservoir for cleaning and stimulation.

2. The binary mixture system of claim 1 wherein said first-chemical composition comprises sixty percent ammonium nitrate by weight.

3. The binary mixture system of claim 1 wherein said first-chemical composition comprises forty-percent-water by weight.

4. The binary mixture system of claim 1 wherein said first-chemical composition comprises a first-heated temperature of sixty degrees celsius.

5. The binary mixture system of claim 1 wherein said first-chemical composition comprises a ratio of 1.0 to said second-chemical composition and said third-chemical composition.

6. The binary mixture system of claim 1 wherein said first-chemical composition is heated in a tank.

7. The binary mixture system of claim 1 wherein said second-chemical composition comprises forty percent sodium nitrite by weight.

8. The binary mixture system of claim 1 wherein said second-chemical composition comprises sixty-percent-water by weight.

9. The binary mixture system of claim 1 wherein said second-chemical composition comprises a second-heated temperature of sixty degrees celsius.

10. The binary mixture system of claim 1 wherein said second-chemical composition comprises a ratio of 1.56 to said first-chemical composition and said third-chemical composition.

11. The binary mixture system of claim 1 wherein said second-chemical composition is heated in a vessel.

12. The binary mixture system of claim 1 wherein said third-chemical composition comprises eighty-three percent phosphoric acid by weight.

13. The binary mixture system of claim 1 wherein said third-chemical composition comprises seventeen-percent-water by weight.

14. The binary mixture system of claim 1 wherein said third-chemical composition comprises an ambient temperature profile.

15. The binary mixture system of claim 1 wherein said third-chemical composition comprises a ratio of 0.2 to said first-chemical composition and said second-chemical composition.

16. The binary mixture system of claim 1 wherein said binary mixture composition comprises an introduction speed to said oil reservoir of nine liters per second.

17. A binary mixture system comprising:
a binary mixture composition comprising;
a first-chemical composition comprising;
ammonium nitrate-water;
a second-chemical composition comprising;
sodium nitrite-water; and
a third-chemical composition comprising;
phosphoric acid-water;
wherein said binary mixture system comprises said binary mixture composition;
wherein said binary mixture composition comprises said first-chemical composition, said second-chemical composition, and said third-chemical composition;
wherein said first-chemical composition comprises said ammonium nitrate-water;
wherein said second-chemical composition comprises said sodium nitrite-water;
wherein said third-chemical composition comprises said phosphoric acid-water;
wherein said first-chemical composition comprises sixty percent ammonium nitrate by weight;
wherein said first-chemical composition comprises forty-percent-water by weight;
wherein said first-chemical composition comprises a heated temperature of sixty degrees celsius;
wherein said first-chemical composition comprises a ratio of 1.0 to said second-chemical composition and said third-chemical composition;
wherein said first-chemical composition is heated in a tank;
wherein said second-chemical composition comprises forty percent sodium nitrite by weight;
wherein said second-chemical composition comprises sixty-percent-water by weight;
wherein said second-chemical composition comprises a heated temperature of sixty degrees celsius;
wherein said second-chemical composition comprises a ratio of 1.56 to said first-chemical composition and said third-chemical composition;
wherein said second-chemical composition is heated in a vessel;
wherein said third-chemical composition comprises eighty-three percent phosphoric acid by weight;
wherein said third-chemical composition comprises seventeen-percent-water by weight;
wherein said third-chemical composition comprises an ambient temperature profile;
wherein said third-chemical composition comprises a ratio of 0.2 to said first-chemical composition and said second-chemical composition;
wherein said binary mixture composition comprises an introduction speed to said oil reservoir of nine liters per second; and
wherein said binary mixture composition is useful for introduction into a functioning oil reservoir for cleaning and stimulation.

18. The binary mixture system of claim 17 further comprising a kit including:
said first-chemical composition;
said second-chemical composition;
said third-chemical composition; and
a set of user's instructions.

19. A method of using a binary mixture system comprising the steps of:
placing a desired quantity of a first-chemical composition in a tank;
placing a desired quantity of a second-chemical composition in a vessel;
placing a desired quantity of a third-chemical composition in a receptacle;
heating said first-chemical composition and said second-chemical composition to a temperature of sixty degrees celsius;
attaching said tank, said vessel, and said receptacle to hose lines;
releasing said first-chemical composition, said second-chemical composition, and said third-chemical composition into an oil reservoir at a volume of nine liters per second;
monitoring a pressure and said temperature of combined said first-chemical composition, said second-chemical composition, and said third-chemical composition;
discontinuing heating to said first-chemical composition, said second-chemical composition when said temperature of combined said first-chemical composition, said second-chemical composition, and said third-chemical composition reaches eighty degrees celsius;
maintaining a working temperature within a range of two-hundred to two-hundred-fifty degrees celsius; and
discontinuing said release of said first-chemical composition, said second-chemical composition, and said third-chemical composition into said oil reservoir when no longer desired.
